(19) United States
(12) Patent Application Publication
(10) Pub. No.: US 2018/0033011 A1
(43) Pub. Date: Feb. 1, 2018

(54) METHOD AND SYSTEM FOR RISK BASED DECISIONING FOR ONE CLICK CHECKOUT

(71) Applicant: Mastercard International Incorporated, Purchase, NY (US)

(72) Inventors: Manash BHATTACHARJEE, Jersey City, NJ (US); Joseph HAYES, Montclair, NJ (US); Prashant SHARMA, Madison, NJ (US); Sanjay CHALLANI, East Windsor, NJ (US)

(73) Assignee: Mastercard International Incorporated, Purchase, NY (US)

(21) Appl. No.: 15/606,174

(22) Filed: May 26, 2017

Related U.S. Application Data
(60) Provisional application No. 62/369,271, filed on Aug. 1, 2016.

(51) Int. Cl. G06Q 20/40

(52) U.S. Cl. CPC G06Q 20/4016; G06Q 20/4014; G06Q 20/12

(57) ABSTRACT

A method for issuer-based decisioning for single action purchases includes: storing an issuer profile, wherein the issuer profile is a structured data set related to an issuing institution including at least a scoring threshold; receiving data from a web server associated with a merchant, the data comprising at least transaction data related to a proposed payment transaction and browser data related to a web browsing application program used to access the web server; calculating a risk score based on at least the transaction data and browser data; determining a purchase procedure of a plurality of purchase procedures based on the calculated risk score and the scoring threshold, wherein the plurality of purchase procedures includes purchase procedures (i) enabling initiation of the payment transaction via a single user action, and (ii) requiring additional user authentication; and electronically transmitting the determined purchase procedure to the web server.

### FIELD

The present disclosure relates to risk based decisioning for one click checkout for e-commerce payment transactions, specifically the performing of risk-based decisions by issuers to determine if a user should be allowed to initiate an e-commerce payment transaction using a single action.

### BACKGROUND

With the increased accessibility and security of computing devices, more and more consumers purchase items through e-commerce payment transactions, such as may be conducted via Internet webpages or specially designed application programs executed on their computing devices. In many cases, consumers have often been found to prefer making purchases from merchants whose webpages or application programs are easier, and simpler for the consumer to navigate and use. Often times, the more actions the consumer is required to perform, the less likely they are to follow through to initiate the payment transaction.

As a result, the use of “one click” checkout at merchant webpages and application programs has gained traction, particularly with respect to the offerings provided by Amazon® and Paypal®, which enable the consumer to, after their authentication and payment information have been previously provided, skip the traditional shopping cart and payment selection process and initiate a payment transaction from a product screen with a single action. Such methods provide a greater level of consumer convenience, reducing the number of consumers that abandon a purchase.

However, existing methods for one click checkout at merchant webpages and via merchant application programs are performed without communication with the issuing financial institution associated with the transaction account being used to fund the payment transaction. As a result, the issuing financial institution is a party to the payment transaction without being provided the opportunity to evaluate the risk of the payment transaction and use such an evaluation to approve or deny the payment transaction, although in these instances the merchant often accepts the risk involved with the payment transaction.

Thus, there is a need for a technical solution to enable the initiation of an e-commerce payment transaction by a consumer using a single action, whereby the issuing financial institution is configured to evaluate the risk involved with the payment transaction to provide permission for the single action checkout.

### SUMMARY

The present disclosure provides a description of systems and methods for issuer-based decisioning for single action purchases. Enabling the issuing financial institution that issues a transaction account used to fund the payment transaction to evaluate the risk of the payment transaction prior to providing the consumer with an opportunity to initiate the transaction via a single action can ensure that the issuing financial institution is in a similar position with respect to the risk involved in the consumer's participation in payment transactions. In addition, by the issuer evaluating the risk, merchants may be able to provide single action checkout without increasing their own risk in the payment transaction, providing a significant advantage to merchants over traditional one click checkout methods.

A method for issuer-based decisioning for single action purchases includes: storing, in an issuer database of a processing server, an issuer profile, wherein the issuer profile is a structured data set related to an issuing institution including at least a scoring threshold; receiving, by a receiving device of the processing server, data from a web server associated with a merchant, the data comprising at least transaction data related to a proposed payment transaction and browser data related to a web browsing application program used to access the web server; calculating, by a calculation module of the processing server, a risk score based on at least the transaction data and browser data; determining, by a determination module, a purchase procedure of a plurality of purchase procedures based on the calculated risk score and the scoring threshold, wherein the plurality of purchase procedures includes purchase procedures (i) enabling initiation of the payment transaction via a single user action, and (ii) requiring additional user authentication; and electronically transmitting, by a transmitting device of the processing server, the determined purchase procedure to the web server.

Another method for issuer-based decisioning for single action purchases includes: receiving, by a receiving device of a processing server, data from a web server associated with a merchant, the data comprising at least transaction data related to a proposed payment transaction and browser data related to a web browsing application program used to access the web server; determining, by a determination module of the processing server, a user identifier token based on at least the browser data; electronically transmitting, by a transmitting device of the processing server, at least the browser data, transaction data, and user identifier token to an issuing institution; receiving, by the receiving device of the processing server, a purchase procedure from the issuing institution, wherein the purchase procedure is one of a plurality of purchase procedures including purchase procedures (i) enabling initiation of the payment transaction via a single user action, and (ii) requiring additional user authentication; and electronically transmitting, by the transmitting device of the processing server, the received purchase procedure to the web server.

A system for issuer-based decisioning for single action purchases includes: an issuer database of a processing server configured to store an issuer profile, wherein the issuer profile is a structured data set related to an issuing institution including at least a scoring threshold; a receiving device of the processing server configured to receive data from a web server associated with a merchant, the data comprising at least transaction data related to a proposed payment transaction and browser data related to a web browsing application program used to access the web server; a calculation module of the processing server configured to calculate a risk score based on at least the transaction data and browser data; a determination module configured to determine a purchase procedure of a plurality of purchase procedures based on the calculated risk score and the scoring threshold, wherein the plurality of purchase procedures includes purchase procedures (i) enabling initiation of the payment transaction via a single user action, and (ii) requiring additional user authentication; and a transmitting device of the processing server configured to electronically transmit the determined purchase procedure to the web server.

Another system for issuer-based decisioning for single action purchases includes: a receiving device of a processing server configured to receive data from a web server associated with a merchant, the data comprising at least transaction data related to a proposed payment transaction and browser data related to a web browsing application program used to access the web server; a determination module of the processing server configured to determine a user identifier token based on at least the browser data; and a transmitting device of the processing server configured to electronically transmit at least the browser data, transaction data, and user identifier token to an issuing institution. The receiving device of the processing server is further configured to receive a purchase procedure from the issuing institution, wherein the purchase procedure is one of a plurality of purchase procedures including purchase procedures (i) enabling initiation of the payment transaction via a single user action, and (ii) requiring additional user authentication. The transmitting device of the processing server is further configured to electronically transmit the received purchase procedure to the web server.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for issuer-based decisioning for single action purchases in accordance with exemplary embodiments.

FIG. 2 is a block diagram illustrating the processing server of the system of FIG. 1 for the scoring of payment transactions and conveyance of transaction data for issuer-based decisioning for single action purchases in accordance with exemplary embodiments.

FIG. 3 is a flow diagram illustrating a process for issuer-based decisioning for single action purchases based on risk scoring performed by the processing server of FIG. 2 using the system of FIG. 1 in accordance with exemplary embodiments.

FIG. 4 is a flow diagram illustrating a process for issuer-based decisioning for single action purchases based on data conveyed by the processing server of FIG. 2 using the system of FIG. 1 in accordance with exemplary embodiments.

FIGS. 5 and 6 are flow charts illustrating exemplary methods for issuer-based decisioning for single action purchases in accordance with exemplary embodiments.

FIG. 7 is a flow diagram illustrating the processing of a payment transaction in accordance with exemplary embodiments.

FIG. 8 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

### System for Issuer-Based Decisioning for Single Action Purchases

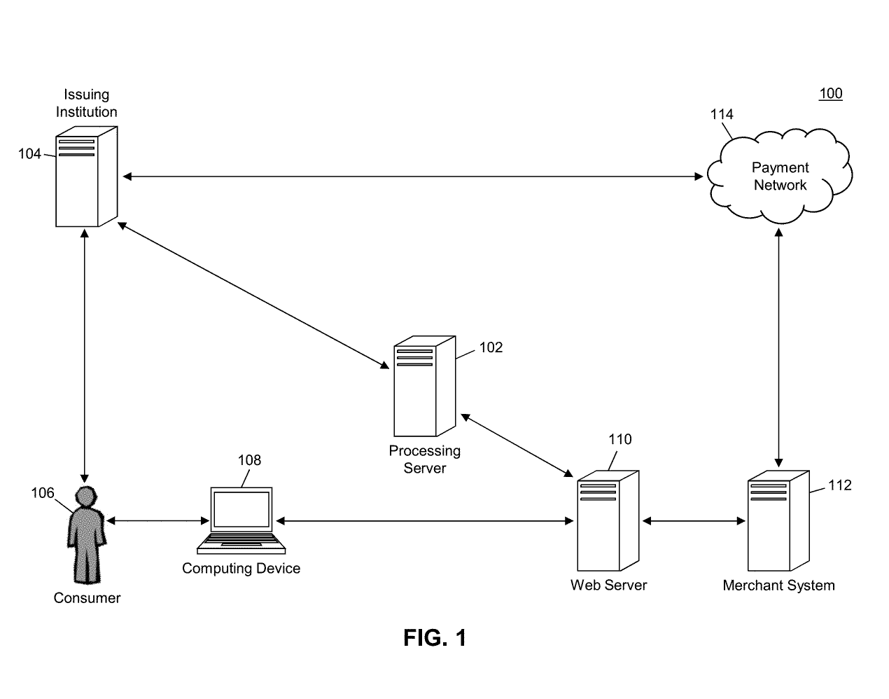

FIG. 1 illustrates a system 100 for single action purchases for e-commerce payment transactions based on decisions performed by an issuing financial institution based on an evaluation of risk for the payment transaction.

The system 100 may include a processing server 102. The processing server 102, discussed in more detail below, may be configured to calculate risk scores for potential e-commerce payment transactions for use by an issuing institution 104 in evaluating the risk for the potential transaction to determine if a consumer 106 should be enable to initiate the payment transaction via a single action. In some embodiments, the processing server 102 may be configured to convey data to the issuing institution 104 for use in the calculation of a risk score by the issuing institution 104.

The issuing institution 104 may be a financial institution, such as an issuing bank, or other entity configured to issue transaction accounts to consumers 106 for use in funding payment transactions, including e-commerce payment transactions that may be conducted via a webpage, application program, or other such means as will be apparent to persons having skill in the relevant art. The issuing institution 104 may issue a transaction account to a consumer 106, and may provide the consumer 106 with payment credentials associated with the transaction account, which may be presented to a merchant for use in funding a payment transaction.

The consumer 106 may possess a computing device 108, which the consumer 106 may use to access a merchant webpage, application program, or other suitable type of platform to select products for purchase. The computing device 108 may be any type of computing device suitable for performing the functions discussed herein, such as a desktop computer, laptop computer, notebook computer, tablet computer, cellular phone, smart phone, smart watch, smart television, wearable computing device, implantable computing device, etc. The merchant webpage, application program, or other suitable platform that is accessed by the consumer 106 via the computing device 108 may be hosted, presented, or otherwise in communication with a web server 110.

The web server 110 may be a server operating on behalf of, operated by, under the instruction of, or otherwise associated with a merchant system 112 that is associated with a merchant that is to participate in the payment transaction. In some instances, the merchant system 112 may include the web server 110. The consumer 106 may thus use the computing device 108 to browse for one or more products (e.g., goods or services) for purchase from the merchant associated with the merchant system 112, where such data may be electronically transmitted from the web server 110 to the computing device 108.

The web server 110 may be configured to electronically communicate with the processing server 102 via a suitable communication network and method, such as via the Internet, a local area network, wireless area network, radio frequency, etc. When the consumer 106 visits the merchant webpage, executes the application program, or otherwise accesses the platform, the web server 110 may electronically transmit data to the processing server 102 associated therewith, which may be comprised of at least transaction data and browser data. The transaction data may be data associated with the potential payment transaction, while the browser data may include data associated with the web browser (e.g., or other application program) executed by the computing device 108 to access the platform and/or the consumer 106.

For example, transaction data may include data associated with the merchant involved in the payment transaction, such as a merchant identification number, merchant name, merchant category code, etc., as well as data associated with the transaction itself such as the time and date, geographic location, and, if the consumer 106 has navigated to a page for the purchase of a specific product or products (e.g., a product page, checkout page, etc.), the transaction data may include product data for the products, a transaction amount, etc. The browser data may include data associated with the application program used to access the platform (e.g., name, version, headers, metadata, browser fingerprint, etc.), data associated with the computing device 108 (e.g., internet protocol address, media access control address, operating system data, etc.), and data associated with the consumer 106.

The data associated with the consumer 106 may be data used for identification of the consumer, such as an e-mail address, telephone number, username, etc. In some instances, the data associated with the consumer 106 may be hashed or otherwise obscured such that the processing server 102 may not possess any personally identifiable information associated with the consumer 106. In some embodiments, the data may include a user identifier token. The user identifier token may be associated with the consumer 106 and used for identification thereof by the processing server 102 and/or consumer 106. In some instances, the user identifier token may be comprised of a random or pseudo-random value (e.g., an alphanumeric value) suitable for use in identification.

In some instances, the transaction data and/or browser data or data included therein may be included in a cookie, which may be transmitted to the processing server 102 by the web server 110 or obtained by the processing server 102 directly from the computing device 108 using methods and systems that will be apparent to persons having skill in the relevant art. For instance, the computing device 108 may store a cookie that includes the user identifier token associated with the consumer 106, that may be read by the web server 110 and electronically transmitted to the processing server 102 with the other data being provided for the issuer-based risk determination.

Once the processing server 102 has received the data, then, in some embodiments, the processing server 102 may be configured to calculate a risk score for the potential payment transaction based thereon. The risk score may be based on at least the data made available to the processing server 102 as provided by the web server 110 and may be an evaluation of the potential payment transaction, the involved merchant, the consumer 106, and the computing device 108 to determine a level of trustworthiness for the consumer 106 and/or merchant, represented via the calculated risk score. For instance, if the consumer 106 has navigated to a page for an expensive product at a disreputable merchant located in another country, the calculated risk score may be very high. On the other hand, if the consumer 106 has navigated to a web page for an inexpensive product from a local merchant with a good reputation, the calculated risk score may be low.

In some embodiments, the processing server 102 may take into account historical data of the consumer 106 and/or the merchant. For instance, the processing server 102 may store risk scores, issuing institution determinations, transaction details (e.g., transaction data, authorization results, etc.) for prior payment transactions, and other data for each consumer 106. In such instances, the data may be stored using the associated user identifier token or other hashed or other data that is not personally identifiable of the associated consumer 106. When a new request is received the processing server 102 may identify the historical data for the consumer 106 using the user identifier token or other consumer data, which may be taken into account for the risk score. For example, if the consumer regularly transacts with the merchant, the risk score may be low. In another example, if the consumer has not transacted with that merchant before, or does not regularly transact with merchants in the particular country where the merchant in question is located, then the risk score may be higher.

The processing server 102 may also base the risk score on historical data associated with the merchant involved in the potential payment transaction. For instance, the processing server 102 may store data associated with payment transactions conducted by, or attempted by, the involved merchant for comparison to the potential payment transaction. In an example, the if the potential payment transaction is for a specific product that is often successfully purchased at the merchant, or for a transaction amount that is typical of purchases made at the merchant, then the risk score may be low. Conversely, if historical purchases with the merchant average between $25 and $250, and the potential payment transaction is for $5,000, then the risk score may be significantly higher.

In some embodiments, once the risk score has been calculated, the processing server 102 may electronically transmit the calculated risk score to the issuing institution 104 using a suitable communication network and method. The issuing institution 104 may, based on the risk score, determine if single action purchasing should be enabled, or if additional user authentication must be required to initiate the payment transaction, such as the consumer 106 logging in to an account with the issuing institution 104 or manually entering payment credentials into the platform. The issuing institution 104 may return a purchase procedure to the processing server 102 that indicates what action the consumer 106 may perform (e.g., initiation of the transaction in a single action, requiring log in, etc.), which may forward the procedure to the web server 110. The web server 110 may then display data associated therewith to the consumer 106, such as, if single action checkout is allowed, a button that the consumer 106 may interact with as the single action to initiate the payment transaction.

In other embodiments, the processing server 102 may be configured to determine if single action checkout is to be allowed. In such embodiments, the issuing institution 104 may provide the processing server 102 with a scoring threshold. For instance, the issuing institution 104 may provide a score value such that any potential payment transaction with a risk score below that value may be initiated via a single action by the consumer 106. The processing server 102 may calculate the risk score for the payment transaction, and, based on the scoring threshold provided by the issuing institution 104, determine the purchase procedure for the consumer 106. The processing server 102 may determine the purchase procedure and then electronically transmit it to the web server 110 for presentation to the consumer 106 via the computing device 108.

In some instances, the processing server 102 may be configured to provide additional information to the issuing institution 104 in addition to the risk score, such as may be used in the issuing institution's determination as to the purchase procedure. For example, the processing server 102 may provide the user identifier token, historical consumer purchase data, historical merchant data, the browser data, the transaction data, or any other additional data that may be used by the issuing institution 104.

Once the consumer 106 is presented with the determined purchase procedure, the consumer 106 may proceed to initiate the payment transaction. For instance, if single click checkout is enabled, the consumer 106 may interact with a single button or hyperlink to initiate the payment transaction. In such instances, payment credentials may be previously known to the web server 110 and/or merchant system 112 (e.g., identified via user data transmitted by the computing device 108, such as the user identifier token), may be provided by the issuing institution 104, may be provided by the processing server 102, or may be communicated by the computing device 108 upon interaction with the button or hyperlink. In instances where the processing server 102 may possess the payment credentials, the payment credentials may be encrypted, tokenized, or otherwise protected from use by the processing server 102 directly. If single click checkout is not enabled, the consumer 106 may be required to provide authentication information and payment credentials using traditional methods.

Once the payment transaction is initiated, the web server 110 may convey the payment credentials, if necessary, and any other transaction data to the merchant system 112 for processing of the payment transaction using traditional methods and systems. The transaction data may include the payment credentials, if applicable, and any additional data associated with the payment transaction used in the processing thereof or for additional functions related thereto, such as a transaction amount, transaction time, transaction data, geographic location, merchant name, merchant identifier, merchant category code, product data, offer data, reward data, loyalty data, issuer data, acquirer data, point of sale data, etc. The merchant system 112 may then electronically transmit the transaction data, with payment credentials included, to a payment network 114 for processing. In some instances, the transaction data may be transmitted directly to the payment network 114 via payment rails associated therewith. In other instances, the transaction data may be transmitted via one or more intermediate entities, such as an acquiring institution or gateway processor.

In some embodiments, the transaction data may be included in a transaction message that is electronically transmitted to the payment network 114 (e.g., by the merchant system 112 or an intermediate entity) via the payment rails associated therewith. A transaction message may be a specially formatted data message that is formatted pursuant to one or more standards governing the exchange of financial transaction messages, such as the International Organization of Standardization's ISO 8583 or ISO 20022 standards. Transaction messages may include message type indicators that are indicative of a type of the payment transaction as well as a plurality of data elements, where each data element is configured to store transaction data for the related payment transaction. In some instances, a transaction message may also include a plurality of bitmaps, which may indicate the data elements included in the transaction message and the data stored therein.

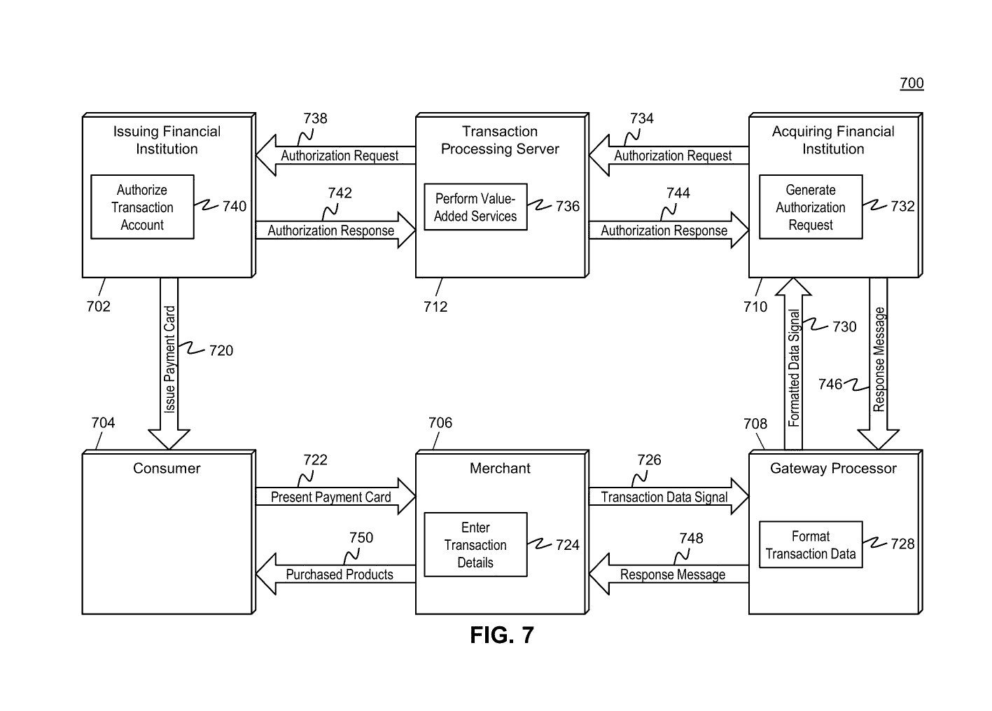

In the system 100, the merchant system 112 may (e.g., via one or more intermediate entities) submit a transaction message to the payment network 114 for the payment transaction that includes a message type indicator indicative of an authorization request and a plurality of data elements configured to store the transaction data. The payment network 114 may perform any functions associated with the processing thereof and may forward the authorization request to the issuing institution 104 for authorization using traditional methods and systems. Additional detail regarding the processing of payment transaction is discussed below with respect to the process 700 illustrated in FIG. 7.

In some embodiments, the processing server 102 may not be configured to calculate risk scores. In such embodiments, the processing server 102 may electronically transmit data to the issuing institution 104 for use in identifying the purchase procedure based thereon. For instance, the processing server 102 may electronically transmit the transaction and browser data to the issuing institution 104, which may, in some cases, be supplemented by historical consumer and/or merchant data for use by the issuing institution 104. In such instances, the processing server 102 may serve as an intermediary between the issuing institution 104 and web server 110 for the potential payment transaction, such that each web server 110 does not have to communicate with multiple issuing institutions 104 and vice versa, and such that the issuing institution 104 may benefit from the extra data that may be provided by the processing server 102 in the determinations.

The methods and systems discussed herein may enable an issuing institution 104 to approve or deny instances where single action initiation of payment transactions for e-commerce payment transactions may be used, either directly (e.g., based on risk scores or data provided by the processing server 102) or indirectly (e.g., by providing a scoring threshold to the processing server 102). As a result, user convenience may be provided, without detriment to the issuing institution 104, and without merchants having to accept extra risk for payment transactions. Thus, issuing institutions 104 may be able to make risk-based decisions for single action or “one click” payment transactions in the system 100, unlike in traditional methods for single action purchases.

### Processing Server

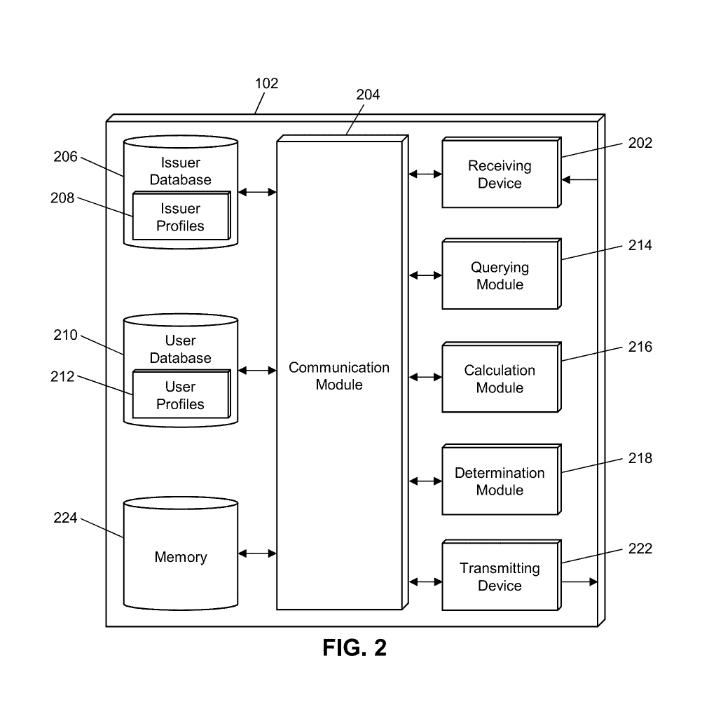

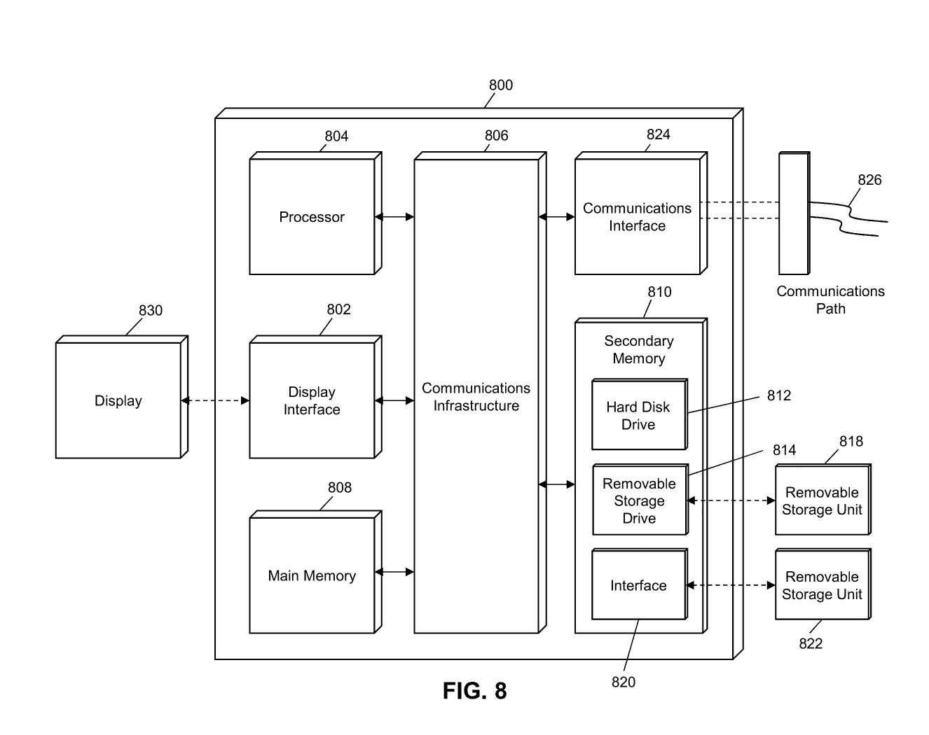

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 800 illustrated in FIG. 8 and discussed in more detail below may be a suitable configuration of the processing server 102.

The processing server 102 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 114 for the transmission of transaction messages that include sensitive financial data and information. In some instances, the receiving device 202 may also be configured to receive data from issuing institutions 104, computing devices 108, web servers 110, payment networks 114, and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by issuing institutions 104, which may be superimposed or otherwise encoded with scoring thresholds and/or purchase procedures. The receiving device 202 may also be configured to receive data signals electronically transmitted by web servers 110, which may be superimposed or otherwise encoded with data associated with potential payment transactions, such as transaction data and browser data. In some instances, the data may include one or more cookies, which may be used to store consumer and/or browser data. In some embodiments, the receiving device 202 may be configured to receive data signals electronically transmitted by computing devices 108, which may be superimposed or otherwise encoded with cookies, which may include user identifier tokens or other data for use in performing the functions discussed herein. In some instances, the receiving device 202 may be configured to receive data signals electronically transmitted by payment networks 114, which may be superimposed or otherwise encoded with transaction data for payment transactions, such as for use as historical data in future risk score calculations.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 214, calculation module 216, determination module 218, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may include an issuer database 206. The issuer database 206 may be configured to store a plurality of issuer profiles 208 using a suitable data storage format and schema. The issuer database 206 may be a relational database that utilizes structured query language for the storage, identification, modifying, updating, accessing, etc. of structured data sets stored therein. Each issuer profile 208 may be a structured data set configured to store data related to an issuing institution 104. Each issuer profile 208 may include at least a scoring threshold, and any other data associated with risk score calculations and purchase procedure determinations, such as data to be provided to the issuing institution 104, algorithms for calculation of risk scores, etc.

The processing server 102 may include a user database 210. The user database 210 may be configured to store a plurality of user profiles 212 using a suitable data storage format and schema. The user database 210 may be a relational database that utilizes structured query language for the storage, identification, modifying, updating, accessing, etc. of structured data sets stored therein. Each user profile 210 may be a structured data set configured to store data related to a consumer 106 and/or computing device 108. A user profile 210 may include at least a user identifier token, and may also be configured to store payment and/or shipping data or historical data associated with the consumer 106, the platform, and/or their payment transactions.

The processing server 102 may include a querying module 214. The querying module 214 may be configured to execute queries on databases to identify information. The querying module 214 may receive one or more data values or query strings, and may execute a query string based thereon on an indicated database, such as the issuer database 206, to identify information stored therein. The querying module 214 may then output the identified information to an appropriate engine or module of the processing server 102 as necessary. The querying module 214 may, for example, execute a query on the issuer database 206 to identify an issuer profile 208 related to an issuing institution 104 that issued a transaction account to be used in a potential payment transaction. The querying module 214 may also be configured to execute queries on the user database 210 to identify a user profile 212 associated with a consumer 106 involved in a potential payment transaction.

The processing server 102 may also include a calculation module 216. The calculation module 216 may be configured to perform calculations of the processing server 102 for performing the functions discussed herein. The calculation module 216 may receive instructions as input, which may be accompanied with data, may perform calculations based on the instructions, and may output a result of the calculations to another module or engine of the processing server 102. For example, the calculation module 216 may be configured to calculate a risk score for a potential payment transaction based on at least transaction data and browser data provided by a web server 110 using a suitable algorithm. In some instances, the algorithm may be identified in the instructions. In other instances, the calculation module 216 may identify the algorithm, which may be generated and modified based on a history of payment transactions approved and/or denied by the issuing institution 104.

The processing server 102 may also include a determination module 218. The determination module 218 may be configured to perform determinations for the processing server 102 for performing the functions discussed herein. The determination module 218 may receive instructions and data as input, may perform one or more determinations based on the data, and may output a result of the determination(s) to another module or engine of the processing server 102. The determination module 218 may be configured to determine a purchase procedure for a potential payment transaction, where the purchase procedure may be one of a plurality of purchase procedures and determined based on a calculated risk score and a scoring threshold. The purchase procedures may include at least one procedure for single action purchases and one procedure for requiring additional user authentication.

The processing server 102 may also include a transmitting device 222. The transmitting device 222 may be configured to transmit data over one or more networks via one or more network protocols. In some embodiments, the transmitting device 222 may be configured to transmit data over the payment rails, such as using specially configured infrastructure associated with payment networks 114 for the transmission of transaction messages that include sensitive financial data and information, such as identified payment credentials. In some instances, the transmitting device 222 may be configured to transmit data to issuing institutions 104, computing devices 108, web servers 110, and other entities via alternative networks, such as the Internet. In some embodiments, the transmitting device 222 may be comprised of multiple devices, such as different transmitting devices for transmitting data over different networks, such as a first transmitting device for transmitting data over the payment rails and a second transmitting device for transmitting data over the Internet. The transmitting device 222 may electronically transmit data signals that have data superimposed that may be parsed by a receiving computing device. In some instances, the transmitting device 222 may include one or more modules for superimposing, encoding, or otherwise formatting data into data signals suitable for transmission.

The transmitting device 222 may be configured to electronically transmit data signals to issuing institutions 104, which may be superimposed or otherwise encoded with calculated risk scores, transaction data, and/or browser data. The transmitting device 222 may also be configured to electronically transmit data signals to web servers 110 that are superimposed or otherwise encoded with purchase procedures for use in the initiation of a payment transaction by the consumer 106. In some instances, the transmitting device 222 may be configured to electronically transmit data signals to computing devices 108 that are superimposed or otherwise encoded with data requests, such as to request cookies including browser data, such as user token identifiers.

The processing server 102 may also include a memory 224. The memory 224 may be configured to store data for use by the processing server 102 in performing the functions discussed herein, such as public and private keys, symmetric keys, etc. The memory 224 may be configured to store data using suitable data formatting methods and schema and may be any suitable type of memory, such as read-only memory, random access memory, etc. The memory 224 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 224 may be comprised of or may otherwise include a relational database that utilizes structured query language for the storage, identification, modifying, updating, accessing, etc. of structured data sets stored therein.

### First Process for Issuer-Based Decisioning for Single Action Purchases

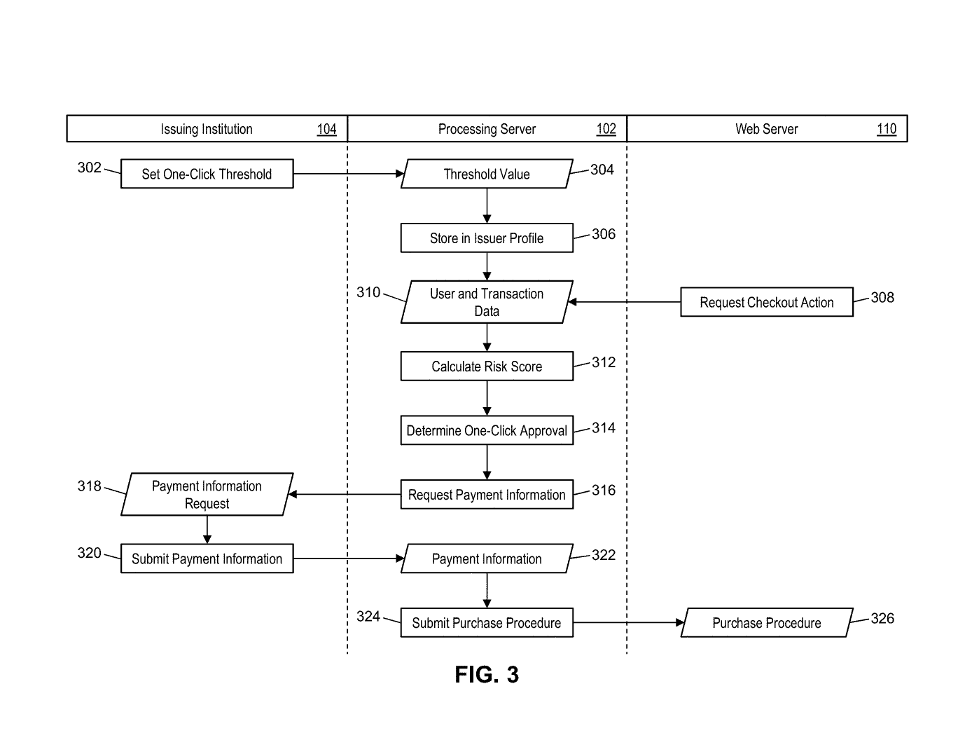

FIG. 3 illustrates a process for the issuer-based decisioning to enable a single action purchase for a potential payment transaction based on a calculated risk score and a scoring threshold provided by an issuing institution 104 associated with a transaction account to be used to fund the potential payment transaction.

In step 302, the issuing institution 104 may electronically transmit a data signal to the processing server 102 that is superimposed or otherwise encoded with a threshold value used to determine if a single action purchase is to be allowed. In step 304, the receiving device 202 of the processing server 102 may receive the threshold value from the issuing institution 104 via a suitable communication network and method. In step 306, the querying module 214 may execute a query on the issuer database 206 to store the threshold value in an issuer profile 208 associated with the issuing institution 104.

In step 308, the web server 110 may electronically transmit a data signal to the processing server 102 that is superimposed or otherwise encoded with a request for a checkout action. In some instances, the request may be initiated based on the consumer 106 navigating to a specific page of the application program or platform, such as a checkout page or a product page. In other instances, the request may be initiated upon connection to the platform, such as execution of the application program associated with the merchant, navigation to the webpage associated with the merchant, etc. In step 310, the receiving device 202 of the processing server 102 may receive the request, which may include transaction data and browser data, where the transaction data includes data associated with the potential payment transaction and where the browser data includes data associated with the platform and data associated with the consumer 106.

In step 312, the calculation module 216 of the processing server 102 may calculate a risk score for the payment transaction. The risk score may be calculated using a suitable scoring algorithm using the transaction and browser data. In step 314, the determination module 218 may determine that the potential payment transaction is approved for one-click purchasing. The determination may be based on the calculated risk score being below the threshold value set by the issuing institution 104.

In step 316, the transmitting device 222 may electronically transmit a data signal to the issuing institution 104 to request payment information, shipping information, or other consumer information necessary for the payment transaction. In step 318, the issuing institution 104 may receive the request, which may include at least a user token identifier or other identifying information associated with the consumer 106, such as a hashed email address, hashed telephone number, computing device identifier, etc. In step 320, the issuing institution 104 may electronically transmit payment information and/or the other consumer information to the processing server 102, to be received by the receiving device 202 of the processing server 102, in step 322. In some instances, steps 316-322 may be optional, and may not be performed in all cases, such as if the web server 110 and/or merchant system 112 possess the payment credentials.

In step 324, the transmitting device 222 of the processing server 102 may electronically transmit a purchase procedure to the web server 110 that indicates that the consumer 106 may initiate the purchase using a single action (e.g., a “one-click purchase”). In instances where payment or other consumer information had been obtained from the issuing institution 104, the purchase procedure may be accompanied by the consumer information. In step 325, the web server 110 may receive the purchase procedure, and may display a page on the application program associated with the indicated purchase procedure.

### Second Process for Issuer-Based Decisioning for Single Action Purchases

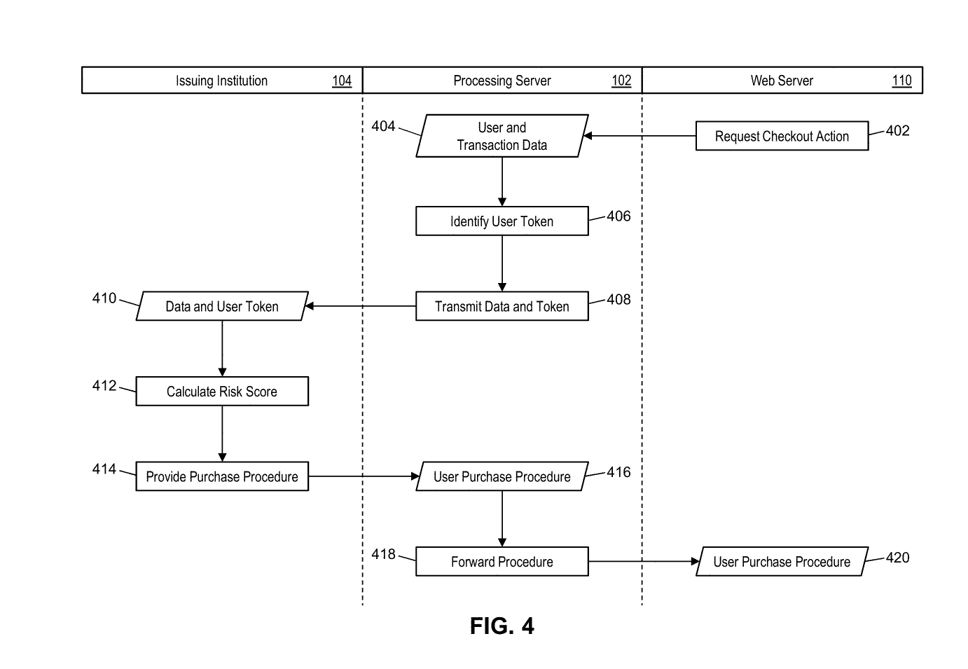

FIG. 4 illustrates a process for the issuer-based decisioning to enable a single action purchase for a potential payment transaction based on transaction and browser data provided to the processing server 102 and forwarded to the issuing institution 104 involved in the potential payment transaction for use in the decisioning.

In step 402, the web server 110 may electronically transmit a data signal to the processing server 102 that is superimposed or otherwise encoded with a request for a checkout action. In some instances, the request may be initiated based on the consumer 106 navigating to a specific page of the application program or platform, such as a checkout page or a product page. In other instances, the request may be initiated upon connection to the platform, such as execution of the application program associated with the merchant, navigation to the webpage associated with the merchant, etc. In step 404, the receiving device 202 of the processing server 102 may receive the request, which may include transaction data and browser data, where the transaction data includes data associated with the potential payment transaction and where the browser data includes data associated with the platform and data associated with the consumer 106.

In step 406, the determination module 218 may determine a user token identifier for the consumer 106 to be involved in the potential payment transaction. In some instances, the user token identifier may be included in the browser data provided from the web server 110. In other instances, the user token identifier may be identified by the determination module 218 based on data included therein. For instance, the determination module 218 may instruction the querying module 214 to execute a query on the user database 210 to identify a user profile 212 in the user database 210 that includes data included in the browser data received from the web server 110. In step 408, the transmitting device 222 of the processing server 102 may electronically transmit the transaction and browser data, as well as the user token identifier, to the issuing institution 104 using a suitable communication network and method.

In step 410, the issuing institution 104 may receive the transaction data, browser data, and user token identifier. In step 412, the issuing institution 104 may calculate a risk score for the payment transaction using at least the transaction and browser data. In some instances, the issuing institution 104 may use additional data associated with the consumer 106 and/or the merchant, such as account data, historical transaction data, etc. In step 414, the issuing institution 104 may forward a purchase procedure to the processing server 102 that is based on the calculated risk score, such as a purchase procedure for a single action purchase or a purchase procedure that requires additional user authentication.

In step 416, the receiving device 202 of the processing server 102 may receive the purchase procedure determined by the issuing institution 104. In step 418, the transmitting device 222 of the processing server 102 may electronically transmit the determined purchase procedure to the web server 110. In step 420, the web server 110 may receive the purchase procedure. The web server 110 may then proceed with enabling the consumer 106 to initiate the payment transaction based on the received purchase procedure.

### First Exemplary Method for Issuer-Based Decisioning for Single Action Purchases

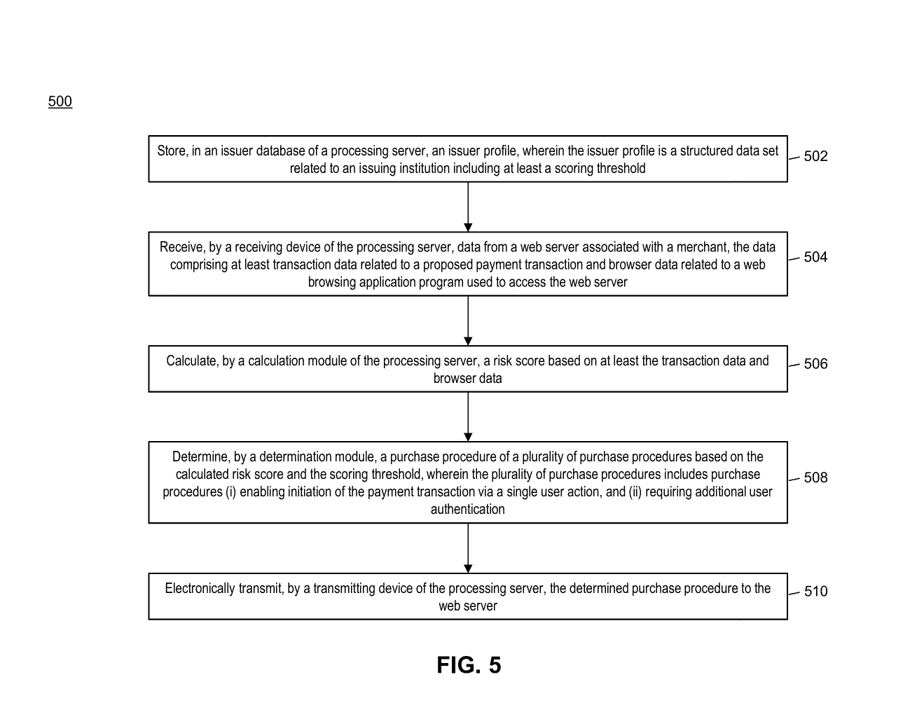

FIG. 5 illustrates a method 500 for issuer-based decisioning for single action purchases based on a calculated risk score and a scoring threshold value associated therewith.

In step 502, an issuer profile (e.g., the issuer profile 208) may be stored in an issuer database (e.g., the issuer database 206) of a processing server (e.g., the processing server 102), wherein the issuer profile is a structured data set related to an issuing institution (e.g., the issuing institution 104) including at least a scoring threshold. In step 504, data associated with a merchant may be received by a receiving device (e.g., the receiving device 202) of the processing server from a web server (e.g., the web server 110), the data comprising at least transaction data related to a proposed payment transaction and browser data related to a web browsing application program used to access the web server.

In step 506, a risk score may be calculated by a calculation module (e.g., the calculation module 216) of the processing server based on at least the transaction data and the browser data. In step 508, a purchase procedure may be determined by a determination module (e.g., the determination module 218) of the processing server, the purchase procedure being one of a plurality of purchase procedures determined based on the calculated risk score and scoring threshold, wherein the plurality of purchase procedures includes purchase procedures (i) enabling initiation of the payment transaction via a single user action, and (ii) requiring additional user authentication. In step 510, the determined purchase procedure may be electronically transmitted by a transmitting device (e.g., the transmitting device 222) of the processing server to the web server.

In one embodiment, the method 500 may further include storing, in a user database (e.g., the user database 210) of the processing server, a user profile (e.g., the user profile 212), wherein the user profile is a structured data set related to a user of the web browsing application program including at least a user identifier token and payment and/or shipping data, wherein the browser data includes the user identifier token, and electronically transmitting the determined purchase procedure further includes electronically transmitting the payment and/or shipping data. In some embodiments, the method 500 may also include receiving, by the receiving device of the processing server, the scoring threshold from the issuing institution prior to storage of the issuer profile in the issuer database.

In one embodiment, the method 500 may further include electronically transmitting, by the transmitting device of the processing server, a data request to the issuing institution, wherein the data request includes a user identifier token; and receiving, by the receiving device of the processing server, payment and/or shipping data from the issuing institution, wherein the browser data includes the user identifier token, and electronically transmitting the determined purchase procedure further includes electronically transmitting the payment and/or shipping data. In some embodiments, the data received from the web server may include at least a cookie, the cookie storing at least a user token identifier.

### Second Exemplary Method for Issuer-Based Decisioning for Single Action Purchases

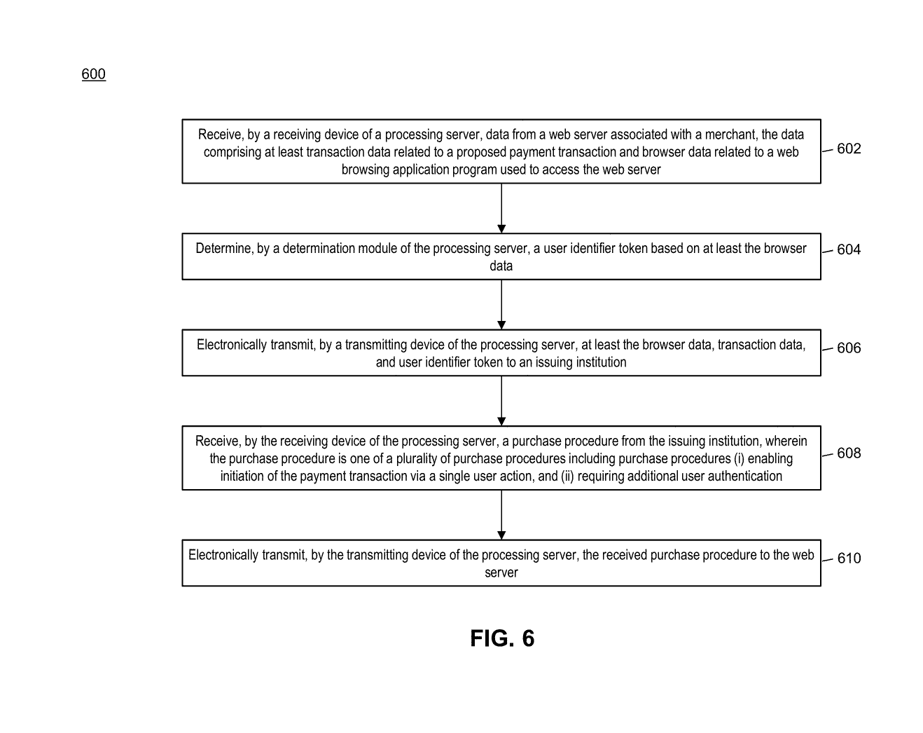

FIG. 6 illustrates a method 600 for issuer-based decisioning for single action purchases based on a calculated risk score and a scoring threshold value associated therewith.

In step 602, data associated with a merchant may be received from a web server (e.g., the web server 110) by a receiving device (e.g., the receiving device 202) of a processing server (e.g., the processing server 102), wherein the data comprises at least transaction data related to a proposed payment transaction and browser data related to a web browsing application program used to access the web server. In step 604, a user identifier token may be determined by a determination module (e.g., the determination module 218) of the processing server based on at least the browser data.

In step 606, at least the browser data, transaction data, and user identifier token may be electronically transmitted by a transmitting device (e.g., the transmitting device 222) of the processing server to an issuing institution (e.g., the issuing institution 104). In step 608, a purchase procedure may be received by the receiving device of the processing server from the issuing institution, wherein the purchase procedure is one of a plurality of purchase procedures including purchase procedures (i) enabling initiation of the payment transaction via a single user action, and (ii) requiring additional user authentication. In step 610, the received purchase procedure may be electronically transmitted by the transmitting device of the processing server to the web server.

In one embodiment, the purchase procedure may be accompanied by payment and/or shipping data, and electronically transmitting the determined purchase procedure further includes electronically transmitting the payment and/or shipping data. In some embodiments, the method 600 may further include calculating, by a calculation module (e.g., the calculation module 216) of the processing server, a risk score based on at least the transaction data and browser data, wherein electronically transmitting the browser data, transaction data, and user identifier token further comprises electronically transmitting the calculated risk score to the issuing institution.

In one embodiment, the method 600 may also include calculating, by a calculation module of the processing server, a risk score based on at least the transaction data and browser data, wherein the calculated risk score is electronically transmitted to the issuing institution in place of the browser data and transaction data. In some embodiments, the data received from the web server may include at least a cookie, the cookie storing at least a user token identifier.

### Payment Transaction Processing System and Process

FIG. 7 illustrates a transaction processing system and a process 700 for the processing of payment transactions in the system, which may include the processing of thousands, millions, or even billions of transactions during a given period (e.g., hourly, daily, weekly, etc.). The process 700 and steps included therein may be performed by one or more components of the system 100 discussed above, such as the issuing institution 104, issuer 106, merchant system 112, payment network 114, etc. The processing of payment transactions using the system and process 700 illustrated in FIG. 7 and discussed below may utilize the payment rails, which may be comprised of the computing devices and infrastructure utilized to perform the steps of the process 700 as specially configured and programmed by the entities discussed below, including the transaction processing server 712, which may be associated with one or more payment networks configured to processing payment transactions. It will be apparent to persons having skill in the relevant art that the process 700 may be incorporated into the processes illustrated in FIGS. 3-6, discussed above, with respect to the step or steps involved in the processing of a payment transaction. In addition, the entities discussed herein for performing the process 700 may include one or more computing devices or systems configured to perform the functions discussed below. For instance, the merchant 706 may be comprised of one or more point of sale devices, a local communication network, a computing server, and other devices configured to perform the functions discussed below.

In step 720, an issuing financial institution 702 may issue a payment card or other suitable payment instrument to a consumer 704. The issuing financial institution may be a financial institution, such as a bank, or other suitable type of entity that administers and manages payment accounts and/or payment instruments for use with payment accounts that can be used to fund payment transactions. The consumer 704 may have a transaction account with the issuing financial institution 702 for which the issued payment card is associated, such that, when used in a payment transaction, the payment transaction is funded by the associated transaction account. In some embodiments, the payment card may be issued to the consumer 704 physically. In other embodiments, the payment card may be a virtual payment card or otherwise provisioned to the consumer 704 in an electronic format.

In step 722, the consumer 704 may present the issued payment card to a merchant 706 for use in funding a payment transaction. The merchant 706 may be a business, another consumer, or any entity that may engage in a payment transaction with the consumer 704. The payment card may be presented by the consumer 704 via providing the physical card to the merchant 706, electronically transmitting (e.g., via near field communication, wireless transmission, or other suitable electronic transmission type and protocol) payment details for the payment card, or initiating transmission of payment details to the merchant 706 via a third party. The merchant 706 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 724, the merchant 706 may enter transaction details into a point of sale computing system. The transaction details may include the payment details provided by the consumer 704 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 706 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 706 may be an online retailer in an e-commerce transaction. In such embodiments, the transaction details may be entered in a shopping cart or other repository for storing transaction data in an electronic transaction as will be apparent to persons having skill in the relevant art.

In step 726, the merchant 706 may electronically transmit a data signal superimposed with transaction data to a gateway processor 708. The gateway processor 708 may be an entity configured to receive transaction details from a merchant 706 for formatting and transmission to an acquiring financial institution 710. In some instances, a gateway processor 708 may be associated with a plurality of merchants 706 and a plurality of acquiring financial institutions 710. In such instances, the gateway processor 708 may receive transaction details for a plurality of different transactions involving various merchants, which may be forwarded on to appropriate acquiring financial institutions 710. By having relationships with multiple acquiring financial institutions 710 and having the requisite infrastructure to communicate with financial institutions using the payment rails, such as using application programming interfaces associated with the gateway processor 708 or financial institutions used for the submission, receipt, and retrieval of data, a gateway processor 708 may act as an intermediary for a merchant 706 to be able to conduct payment transactions via a single communication channel and format with the gateway processor 708, without having to maintain relationships with multiple acquiring financial institutions 710 and payment processors and the hardware associated thereto. Acquiring financial institutions 710 may be financial institutions, such as banks, or other entities that administers and manages payment accounts and/or payment instruments for use with payment accounts. In some instances, acquiring financial institutions 710 may manage transaction accounts for merchants 706. In some cases, a single financial institution may operate as both an issuing financial institution 702 and an acquiring financial institution 710.

The data signal transmitted from the merchant 706 to the gateway processor 708 may be superimposed with the transaction details for the payment transaction, which may be formatted based on one or more standards. In some embodiments, the standards may be set forth by the gateway processor 708, which may use a unique, proprietary format for the transmission of transaction data to/from the gateway processor 708. In other embodiments, a public standard may be used, such as the International Organization for Standardization's ISO 8583 standard. The standard may indicate the types of data that may be included, the formatting of the data, how the data is to be stored and transmitted, and other criteria for the transmission of the transaction data to the gateway processor 708.

In step 728, the gateway processor 708 may parse the transaction data signal to obtain the transaction data superimposed thereon and may format the transaction data as necessary. The formatting of the transaction data may be performed by the gateway processor 708 based on the proprietary standards of the gateway processor 708 or an acquiring financial institution 710 associated with the payment transaction. The proprietary standards may specify the type of data included in the transaction data and the format for storage and transmission of the data. The acquiring financial institution 710 may be identified by the gateway processor 708 using the transaction data, such as by parsing the transaction data (e.g., deconstructing into data elements) to obtain an account identifier included therein associated with the acquiring financial institution 710. In some instances, the gateway processor 708 may then format the transaction data based on the identified acquiring financial institution 710, such as to comply with standards of formatting specified by the acquiring financial institution 710. In some embodiments, the identified acquiring financial institution 710 may be associated with the merchant 706 involved in the payment transaction, and, in some cases, may manage a transaction account associated with the merchant 706.

In step 730, the gateway processor 708 may electronically transmit a data signal superimposed with the formatted transaction data to the identified acquiring financial institution 710. The acquiring financial institution 710 may receive the data signal and parse the signal to obtain the formatted transaction data superimposed thereon. In step 732, the acquiring financial institution may generate an authorization request for the payment transaction based on the formatted transaction data. The authorization request may be a specially formatted transaction message that is formatted pursuant to one or more standards, such as the ISO 8583 standard and standards set forth by a payment processor used to process the payment transaction, such as a payment network. The authorization request may be a transaction message that includes a message type indicator indicative of an authorization request, which may indicate that the merchant 706 involved in the payment transaction is requesting payment or a promise of payment from the issuing financial institution 702 for the transaction. The authorization request may include a plurality of data elements, each data element being configured to store data as set forth in the associated standards, such as for storing an account number, application cryptogram, transaction amount, issuing financial institution 702 information, etc.

In step 734, the acquiring financial institution 710 may electronically transmit the authorization request to a transaction processing server 712 for processing. The transaction processing server 712 may be comprised of one or more computing devices as part of a payment network configured to process payment transactions. In some embodiments, the authorization request may be transmitted by a transaction processor at the acquiring financial institution 710 or other entity associated with the acquiring financial institution. The transaction processor may be one or more computing devices that include a plurality of communication channels for communication with the transaction processing server 712 for the transmission of transaction messages and other data to and from the transaction processing server 712. In some embodiments, the payment network associated with the transaction processing server 712 may own or operate each transaction processor such that the payment network may maintain control over the communication of transaction messages to and from the transaction processing server 712 for network and informational security.

In step 736, the transaction processing server 712 may perform value-added services for the payment transaction. Value-added services may be services specified by the issuing financial institution 702 that may provide additional value to the issuing financial institution 702 or the consumer 704 in the processing of payment transactions. Value-added services may include, for example, fraud scoring, transaction or account controls, account number mapping, offer redemption, loyalty processing, etc. For instance, when the transaction processing server 712 receives the transaction, a fraud score for the transaction may be calculated based on the data included therein and one or more fraud scoring algorithms and/or engines. In some instances, the transaction processing server 712 may first identify the issuing financial institution 702 associated with the transaction, and then identify any services indicated by the issuing financial institution 702 to be performed. The issuing financial institution 702 may be identified, for example, by data included in a specific data element included in the authorization request, such as an issuer identification number. In another example, the issuing financial institution 702 may be identified by the primary account number stored in the authorization request, such as by using a portion of the primary account number (e.g., a bank identification number) for identification.

In step 738, the transaction processing server 712 may electronically transmit the authorization request to the issuing financial institution 702. In some instances, the authorization request may be modified, or additional data included in or transmitted accompanying the authorization request as a result of the performance of value-added services by the transaction processing server 712. In some embodiments, the authorization request may be transmitted to a transaction processor (e.g., owned or operated by the transaction processing server 712) situated at the issuing financial institution 702 or an entity associated thereof, which may forward the authorization request to the issuing financial institution 702.

In step 740, the issuing financial institution 702 may authorize the transaction account for payment of the payment transaction. The authorization may be based on an available credit amount for the transaction account and the transaction amount for the payment transaction, fraud scores provided by the transaction processing server 712, and other considerations that will be apparent to persons having skill in the relevant art. The issuing financial institution 702 may modify the authorization request to include a response code indicating approval (e.g., or denial if the transaction is to be denied) of the payment transaction. The issuing financial institution 702 may also modify a message type indicator for the transaction message to indicate that the transaction message is changed to be an authorization response. In step 742, the issuing financial institution 702 may transmit (e.g., via a transaction processor) the authorization response to the transaction processing server 712.

In step 744, the transaction processing server 712 may forward the authorization response to the acquiring financial institution 710 (e.g., via a transaction processor). In step 746, the acquiring financial institution may generate a response message indicating approval or denial of the payment transaction as indicated in the response code of the authorization response, and may transmit the response message to the gateway processor 708 using the standards and protocols set forth by the gateway processor 708. In step 748, the gateway processor 708 may forward the response message to the merchant 706 using the appropriate standards and protocols. In step 770, assuming the transaction was approved, the merchant 706 may then provide the products purchased by the consumer 704 as part of the payment transaction to the consumer 704.

In some embodiments, once the process 700 has completed, payment from the issuing financial institution 702 to the acquiring financial institution 710 may be performed. In some instances, the payment may be made immediately or within one business day. In other instances, the payment may be made after a period of time, and in response to the submission of a clearing request from the acquiring financial institution 710 to the issuing financial institution 702 via the transaction processing server 712. In such instances, clearing requests for multiple payment transactions may be aggregated into a single clearing request, which may be used by the transaction processing server 712 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 740), the transaction processing server 712 may be configured to perform authorization of transactions on behalf of the issuing financial institution 702. Such actions may be referred to as “stand-in processing,” where the transaction processing server “stands in” as the issuing financial institution 702. In such instances, the transaction processing server 712 may utilize rules set forth by the issuing financial institution 702 to determine approval or denial of the payment transaction, and may modify the transaction message accordingly prior to forwarding to the acquiring financial institution 710 in step 744. The transaction processing server 712 may retain data associated with transactions for which the transaction processing server 712 stands in, and may transmit the retained data to the issuing financial institution 702 once communication is reestablished. The issuing financial institution 702 may then process transaction accounts accordingly to accommodate for the time of lost communication.

In another example, if the transaction processing server 712 is unavailable for submission of the authorization request by the acquiring financial institution 710, then the transaction processor at the acquiring financial institution 710 may be configured to perform the processing of the transaction processing server 712 and the issuing financial institution 702. The transaction processor may include rules and data suitable for use in making a determination of approval or denial of the payment transaction based on the data included therein. For instance, the issuing financial institution 702 and/or transaction processing server 712 may set limits on transaction type, transaction amount, etc. that may be stored in the transaction processor and used to determine approval or denial of a payment transaction based thereon. In such instances, the acquiring financial institution 710 may receive an authorization response for the payment transaction even if the transaction processing server 712 is unavailable, ensuring that transactions are processed and no downtime is experienced even in instances where communication is unavailable. In such cases, the transaction processor may store transaction details for the payment transactions, which may be transmitted to the transaction processing server 712 (e.g., and from there to the associated issuing financial institutions 702) once communication is reestablished.

In some embodiments, transaction processors may be configured to include a plurality of different communication channels, which may utilize multiple communication cards and/or devices, to communicate with the transaction processing server 712 for the sending and receiving of transaction messages. For example, a transaction processor may be comprised of multiple computing devices, each having multiple communication ports that are connected to the transaction processing server 712. In such embodiments, the transaction processor may cycle through the communication channels when transmitting transaction messages to the transaction processing server 712, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 710 may identify that an authorization request involves an issuing financial institution 702 (e.g., via the bank identification number included in the transaction message) for which no value-added services are required. The transaction processor at the acquiring financial institution 710 may then transmit the authorization request directly to the transaction processor at the issuing financial institution 702 (e.g., without the authorization request passing through the transaction processing server 712), where the issuing financial institution 702 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 712 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 708, acquiring financial institution 710, etc.) for processing using this advanced network, and to quickly and efficiently receive a response regarding the ability for a consumer 704 to fund the payment transaction.

### Computer System Architecture

FIG. 8 illustrates a computer system 800 in which embodiments of the present disclosure, or portions thereof, may be implemented as computer-readable code. For example, the processing server 102 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-7.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device specifically configured to perform the functions discussed herein. The processor device 804 may be connected to a communications infrastructure 806, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive or universal serial bus port, the removable storage unit 818 may be a floppy disk or portable flash drive, respectively. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

Data stored in the computer system 800 (e.g., in the main memory 808 and/or the secondary memory 810) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

The computer system 800 may further include a display interface 802. The display interface 802 may be configured to allow data to be transferred between the computer system 800 and external display 830. Exemplary display interfaces 802 may include high-definition multimedia interface (HDMI), digital visual interface (DVI), video graphics array (VGA), etc. The display 830 may be any suitable type of display for displaying data transmitted via the display interface 802 of the computer system 800, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 808 and secondary memory 810, which may be memory semiconductors (e.g., DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 3-7, as discussed herein. Accordingly, such computer programs may represent controllers of the computer system 800. Where the present disclosure is implemented using software, the software may be stored in a computer program product and loaded into the computer system 800 using the removable storage drive 814, interface 820, and hard disk drive 812, or communications interface 824.

The processor device 804 may comprise one or more modules or engines configured to perform the functions of the computer system 800. Each of the modules or engines may be implemented using hardware and, in some instances, may also utilize software, such as corresponding to program code and/or programs stored in the main memory 808 or secondary memory 810. In such instances, program code may be compiled by the processor device 804 (e.g., by a compiling module or engine) prior to execution by the hardware of the computer system 800. For example, the program code may be source code written in a programming language that is translated into a lower level language, such as assembly language or machine code, for execution by the processor device 804 and/or any additional hardware components of the computer system 800. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 800 to perform the functions disclosed herein. It will be apparent to persons having skill in the relevant art that such processes result in the computer system 800 being a specially configured computer system 800 uniquely programmed to perform the functions discussed above.

Techniques consistent with the present disclosure provide, among other features, systems and methods for issuer-based decisioning for single action purchases. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope. cm What is claimed is:

1. A method for issuer-based decisioning for single action purchases, comprising:
storing, in an issuer database of a processing server, an issuer profile, wherein the issuer profile is a structured data set related to an issuing institution including at least a scoring threshold;
receiving, by a receiving device of the processing server, data from a web server associated with a merchant, the data comprising at least transaction data related to a proposed payment transaction and browser data related to a web browsing application program used to access the web server;
calculating, by a calculation module of the processing server, a risk score based on at least the transaction data and browser data;
determining, by a determination module, a purchase procedure of a plurality of purchase procedures based on the calculated risk score and the scoring threshold, wherein the plurality of purchase procedures includes purchase procedures (i) enabling initiation of the payment transaction via a single user action, and (ii) requiring additional user authentication; and
electronically transmitting, by a transmitting device of the processing server, the determined purchase procedure to the web server.

2. The method of claim 1, further comprising:
storing, in a user database of the processing server, a user profile, wherein the user profile is a structured data set related to a user of the web browsing application program including at least a user identifier token and payment and/or shipping data, wherein
the browser data includes the user identifier token, and
electronically transmitting the determined purchase procedure further includes electronically transmitting the payment and/or shipping data.

3. The method of claim 1, further comprising:
electronically transmitting, by the transmitting device of the processing server, a data request to the issuing institution, wherein the data request includes a user identifier token; and
receiving, by the receiving device of the processing server, payment and/or shipping data from the issuing institution, wherein
the browser data includes the user identifier token, and
electronically transmitting the determined purchase procedure further includes electronically transmitting the payment and/or shipping data.

4. The method of claim 1, further comprising:
receiving, by the receiving device of the processing server, the scoring threshold from the issuing institution prior to storage of the issuer profile in the issuer database.

5. The method of claim 1, wherein the data received from the web server includes at least a cookie, the cookie storing at least a user token identifier.

6. A method for issuer-based decisioning for single action purchases, comprising:
receiving, by a receiving device of a processing server, data from a web server associated with a merchant, the data comprising at least transaction data related to a proposed payment transaction and browser data related to a web browsing application program used to access the web server;
determining, by a determination module of the processing server, a user identifier token based on at least the browser data;
electronically transmitting, by a transmitting device of the processing server, at least the browser data, transaction data, and user identifier token to an issuing institution;
receiving, by the receiving device of the processing server, a purchase procedure from the issuing institution, wherein the purchase procedure is one of a plurality of purchase procedures including purchase procedures (i) enabling initiation of the payment transaction via a single user action, and (ii) requiring additional user authentication; and
electronically transmitting, by the transmitting device of the processing server, the received purchase procedure to the web server.

7. The method of claim 6, wherein
the purchase procedure is accompanied by payment and/or shipping data, and
electronically transmitting the determined purchase procedure further includes electronically transmitting the payment and/or shipping data.

8. The method of claim 6, further comprising:
calculating, by a calculation module of the processing server, a risk score based on at least the transaction data and browser data, wherein
electronically transmitting the browser data, transaction data, and user identifier token further comprises electronically transmitting the calculated risk score to the issuing institution.

9. The method of claim 6, further comprising:
calculating, by a calculation module of the processing server, a risk score based on at least the transaction data and browser data, wherein
the calculated risk score is electronically transmitted to the issuing institution in place of the browser data and transaction data.

10. The method of claim 6, wherein the data received from the web server includes at least a cookie, the cookie storing at least a user token identifier.

11. A system for issuer-based decisioning for single action purchases, comprising:
an issuer database of a processing server configured to store an issuer profile, wherein the issuer profile is a structured data set related to an issuing institution including at least a scoring threshold;
a receiving device of the processing server configured to receive data from a web server associated with a merchant, the data comprising at least transaction data related to a proposed payment transaction and browser data related to a web browsing application program used to access the web server;
a calculation module of the processing server configured to calculate a risk score based on at least the transaction data and browser data;
a determination module configured to determine a purchase procedure of a plurality of purchase procedures based on the calculated risk score and the scoring threshold, wherein the plurality of purchase procedures includes purchase procedures (i) enabling initiation of the payment transaction via a single user action, and (ii) requiring additional user authentication; and
a transmitting device of the processing server configured to electronically transmit the determined purchase procedure to the web server.

12. The system of claim 11, further comprising:
a user database of the processing server configured to store a user profile, wherein the user profile is a structured data set related to a user of the web browsing application program including at least a user identifier token and payment and/or shipping data, wherein
the browser data includes the user identifier token, and
electronically transmitting the determined purchase procedure further includes electronically transmitting the payment and/or shipping data.

13. The system of claim 11, wherein
the transmitting device of the processing server is further configured to electronically transmit a data request to the issuing institution, wherein the data request includes a user identifier token
the receiving device of the processing server is further configured to receive payment and/or shipping data from the issuing institution,
the browser data includes the user identifier token, and
electronically transmitting the determined purchase procedure further includes electronically transmitting the payment and/or shipping data.

14. The system of claim 11, wherein the receiving device of the processing server is further configured to receive the scoring threshold from the issuing institution prior to storage of the issuer profile in the issuer database.

15. The system of claim 11, wherein the data received from the web server includes at least a cookie, the cookie storing at least a user token identifier.

16. A system for issuer-based decisioning for single action purchases, comprising:
a receiving device of a processing server configured to receive data from a web server associated with a merchant, the data comprising at least transaction data related to a proposed payment transaction and browser data related to a web browsing application program used to access the web server;
a determination module of the processing server configured to determine a user identifier token based on at least the browser data; and
a transmitting device of the processing server configured to electronically transmit at least the browser data, transaction data, and user identifier token to an issuing institution, wherein
the receiving device of the processing server is further configured to receive a purchase procedure from the issuing institution, wherein the purchase procedure is one of a plurality of purchase procedures including purchase procedures (i) enabling initiation of the payment transaction via a single user action, and (ii) requiring additional user authentication, and
the transmitting device of the processing server is further configured to electronically transmit the received purchase procedure to the web server.

17. The system of claim 16, wherein
the purchase procedure is accompanied by payment and/or shipping data, and
electronically transmitting the determined purchase procedure further includes electronically transmitting the payment and/or shipping data.

18. The system of claim 16, further comprising:
a calculation module of the processing server configured to calculate a risk score based on at least the transaction data and browser data, wherein
electronically transmitting the browser data, transaction data, and user identifier token further comprises electronically transmitting the calculated risk score to the issuing institution.

19. The system of claim 16, further comprising:
a calculation module of the processing server configured to calculate a risk score based on at least the transaction data and browser data, wherein
the calculated risk score is electronically transmitted to the issuing institution in place of the browser data and transaction data.

20. The system of claim 16, wherein the data received from the web server includes at least a cookie, the cookie storing at least a user token identifier.
